(19) United States
(12) Patent Application Publication
(10) Pub. No.: US 2024/0334916 A1
(43) Pub. Date: Oct. 10, 2024

(54) LIGHT HERDING SYSTEM FOR TRAWLS

(71) Applicant: Hampidjan hf, Reykjavik (IS)

(72) Inventors: Hjortur Erlendsson, Kopavogur (IS); Jon Oddur Davidsson, Reyjkavik (IS); Arni Skulason, Kopavogur (IS); Einar Skaftason, Reykjavik (IS); Sherif Safwat, Kailua-Kona, HI (US)

(73) Assignee: Hampidjan hf, Reykjavik (IS)

(21) Appl. No.: 18/391,607

(22) PCT Filed: Jun. 20, 2022
(86) PCT No.: PCT/IS2022/050003

§ 371 Date: Dec. 20, 2023

Related U.S. Application Data
(60) Provisional application No. 63/212,707, filed on Jun. 20, 2021.
(60) Provisional application No. 63/233,060, filed on Aug. 13, 2021.

(30) Foreign Application Priority Data
Jul. 16, 2021 (IS) IS 9151

(51) Int. Cl. A01K 73/06; A01K 75/02

(52) U.S. Cl. CPC A01K 73/06; A01K 75/02

(57) ABSTRACT

A trawl system having at least a trawl net and bridles and/or sweeplines, the trawl net having a trawl mouth opening; wings; a pliable footrope; a pliable headrope; and pliable sidelines, the bridles and/or sweeplines having a forward bridle point as well as having upper and lower bridles and/or sweeplines, the trawl system includes light sources illuminating space between the upper and lower bridles and/or sweeplines with visible light.

### TECHNICAL FIELD

The present disclosure relates to using light rays to herd and/or guide aquatic food species, especially fish, prawns and shrimps into trawls being towed by a fishing vessel, especially midwater trawls and bottom trawls.

### BACKGROUND ART

It is increasingly desired to minimize contact of trawl gear with the sea floor. Attempts at using light to guide aquatic animals into trawls include using a circular and/or elliptical cone of Lights projected outwardly and forward from a frame defining the mouth opening of a trawl so as to form a cone of light projected forward from the mouth of the trawl and in the direction of the path of the trawl. The present state of the art and trend in the industry is disclosed by international publication WO 2008/146310.

However, efficacy of the known art remains inadequate, and a need remains for an apparatus and method for using light to herd fish, shrimps and prawns into the opening of towed trawls that is efficacious and therefore has the possibility to be widely adopted by fishing companies.

### DESCRIPTION

The present disclosure is based upon the discovery that by directing light rays and/or beams rearward and toward a trawl's opening, as opposed to projecting lights forward from a trawl's mouth opening, that an effective and safe means for herding fish into the mouth opening of a towed trawl is achieved. (The terms “light beams” and “light rays” being synonymous for purposes of the present disclosure). Most preferably, light beams of the present disclosure that originate at any region of the trawl system that is forward of the trawl's mouth opening and at and/or between the trawl's mouth opening and the trawl doors and/or forward bridle points are not directed forward, but rather are directed rearward, and in various combinations of both rearward; rearward and downward and/or upward, while also being aimed generally at the peripheral edges of the trawl's mouth opening (and most preferably aimed at the outer peripheral port and starboard side edges of the trawl's mouth opening, although in some cases it may be desirable to also aim the light beams at the upper and/or lower peripheral edges of the trawl's mouth opening). However, light beams of the present disclosure that originate forward of the forward bridle points and/or trawl doors may be directed both forward and outboard of the trawl doors and/or forward bridle points, as well as directed downwards and/or upwards. Such use of lights is contrary to the state of the art and against the knowledge and belief of the industry, that includes forward projecting light waves to herd fish, shrimps and prawns into trawls.

Specifically, in one preferred embodiment, it has been discovered that by forming a pair of walls and/or curtains from visible light in the general shape of a truncated “Vee”, where the truncated narrow portion of the Vee is defined by the walls and/or curtains aft/rearwards boundary being at and/or proximal the port and starboard peripheral edges of the trawl's mouth opening, and the remainder of the walls and/or curtains formed, for each side of the Vee between the upper and lower port and starboard bridle and/or sweep lines, respectively, so that the widest portion of the Vee is defined by a region spanning across and perpendicular the long axis of the trawl net and it's bridles and/or sweeps from a zone at and/or proximal the trawls doors and/or forward bridle points, that an effective light beam herding system for trawls is achieved. In one embodiment, the Vee shaped pair of walls formed of visible light occupies space between a trawl system's upper and lower bridles and/or sweeps and the outer periphery of the trawl's mouth opening, and most preferably occupying space between a trawl system's upper and lower bridles and/or sweeps and the outer peripheral port and starboard side edges of the trawl's mouth opening (and in some cases also between the upper and/or lower peripheral edges of the trawl's mouth opening), and extending from the outer peripheral edges of the trawl's mouth opening to the trawl doors and/or to the forward bridle points. This is as opposed to forming a cone of light rays projected forward from the trawl's opening, as is the state of the art and the trend and belief of those in the industry, that an efficacious and safe means for herding fish into the mouth opening of a towed trawl is achieved.

For example, by forming a “Vee” shaped pair of walls of light rays directed aft toward a trawl's mouth opening and preferably directed toward the outer peripheral edges and especially the outer peripheral port and starboard side edges of a trawl's mouth opening, from a location that is forward of the trawl's opening, such as from the trawl doors and/or from proximal the forward bridle points, as opposed to forming a cone of light rays projected forward from the trawl's opening, that an efficacious and safe means for herding fish into the mouth opening of a towed trawl is achieved.

More specifically, it has been discovered that by forming a “Vee” shaped pair of walls formed of light rays directed aft toward a trawl's opening from trawl doors used to spread horizontally the trawl, and directing the light rays from the trawl doors backward and toward the side edges of the trawl's mouth opening, as opposed to forming a cone of light rays projected forward from the trawl's mouth opening, that an efficacious and safe means for herding fish into the mouth opening of a towed trawl is achieved.

In all cases, the walls and/or curtains of light rays preferably are fully illuminated with visible light, however, dark spots and/or regions in the walls and/or curtains of light forming perforations of unilluminated regions in the walls and/or curtains of light are anticipated useful, with experimentation allowing to determine the exact density of perforations (e.g. “dark” or “unilluminated regions” that is most useful. Preferably, the light rays also are directed downward from the trawl doors toward the bottom so as to create a virtual light curtain along a region that commences directly beneath the trawls doors and extends along the sweeps, bridles and wings while contacting the bottom in the region beneath the sweeps, bridles and wings, and ultimately contacting the side (port and starboard) edges of the trawl's mouth opening.

It also has been discovered that an effective and safe means for herding fish into the mouth of the trawl can be achieved by combining the above mentioned “Vee” shaped pair of walls of light rays directed aft from the trawl doors toward the side edges of the trawls mouth opening, with light rays directed from the trawl's footrope/groundrope downward toward the sea floor so as to create a virtual seal between the trawl's groundrope/footrope and the seafloor. In this embodiment, the light rays directed from the bottom of the trawl, especially from the trawl's groundrope/footrope, may be directed only downward, but more preferably are directed downward and a degree forward that they intersect the sea floor at a distance about two meters forward of the trawl's groundrope/footrope at its center and not more than ten meters in front of the groundrope/footrope at its center, and the light rays even may be a combination of being directed downward with light rays directed downward and forward and/or downward and forward combined with downward and rearward directed light rays, provided that the virtual seal is formed between the trawl's bottom mouth edge and the sea floor.

Contrary to the state of the art and the trend in the industry, no cone of lights is formed emanating forward from the trawl's mouth opening.

More preferably, the apparatus and system includes the above disclosed teachings with light rays directed downward from the upper bridle lines, sweeplines and wing lines toward the sea floor so as to define a virtual light wall between the trawl's upper and lower sweep lines, bridles lines, and between the upper and lower edges of the trawl's wings.

Laser lights are preferred for the lights used in the present apparatus and system, especially for light directed aft from the trawl doors toward the wings and edges of the trawl mouth opening. Strong LED lights also are useful, and in the case of light directed downward and/or downward and forward and/or downward and aft from the footrope, then strong LED lights are also useful.

When the light rays are directed toward portions of the trawl having netting and cordage, such as the wings of the trawl, and the side mouth opening edges of the trawl's cone, and the ground sheet of the trawl (the ground sheet is netting depending from the trawl's groundrope/footrope), the netting preferably is white in color so as to allow it to best reflect light reaching the netting. White netting is preferred when UV light is directed at the netting. Netting that has additives in the cordage material forming the netting which such additives are “glow in the dark” type substances that can be “charged” by light are considered highly useful. Netting formed from cordage that has reflective fibers and/or filaments also is considered useful.

Light waves of various spectrums and wavelengths are anticipated useful, such as orange, red, violet, green, blue, white and others. As different fish species may react differently to specific light waves, it is anticipated that experimentation with different colors of light is useful for determining which light wavelengths are optimal for herding specific species of fish and/or molluscs and/or crustacea, for specific sea conditions, including clarity and plankton density.

One benefit of this system is that no rigid frame is required to form the trawl's mouth opening, but traditional flexible trawls formed from cordage are useful, aiding adopting into the industry.

To use the apparatus and system of the present disclosure, the trawl is towed as usual, except that in the even that the trawl is usually towed in contact with the sea floor, that the trawl is towed a predetermine distance above the sea floor, with the laser and/or strong LED lights mounted on the bottom edge of the trawl's mouth opening forming the virtual seal between the trawl's bottom mouth opening edge, including wing bottom edges, and the sea floor. It presently is anticipated that gaps between the bottom of the trawl's mouth edge including wings and the seafloor of from thirty centimeters to five hundred centimeters is useful. However, when bottom topography permits lesser gaps, then gaps of a minimum amount, even ten or twenty centimeters are useful, provided that contact of the bottom mouth edge and wings of the trawl with the sea floor is eliminated or occurs a minority of the time.

### BRIEF DESCRIPTION OF DRAWINGS

FIG. 1 shows a front view of the trawl system of the present disclosure.

FIG. 1A depicts an alternative embodiment of the trawl system of the present disclosure where the trawl depicted in FIG. 1 is rigged with an alternate arrangement to its bridles and/or sweeplines.

FIG. 2 is a top plan view of the trawl system of the present disclosure depicted in FIG. 1 but lacking lights of the trawl system of the present disclosure. FIGS. 3-7 are alternative embodiments of the trawl system shown in FIG. 1.

FIGS. 8-10 show a top plan view of the trawl system of the present disclosure depicted in FIG. 1 but including lights forming a ceiling of light between the port and starboard upper bridles and headrope.

FIG. 11 depicts an alternative embodiment of the trawl system shown in FIG. 1.

FIG. 12 is a side plan view of one side of an alternative embodiment of the trawl system of FIG. 1 showing one alternate construction and method for affixing and orientating light sources illuminating a wall and/or curtain of light between the upper and lower bridles and/or sweeps of the trawl system.

FIG. 12A depicts an alternate embodiment of the trawl system of the present disclosure where the trawl depicted in FIG. 12 is rigged with an alternate arrangement to its bridles and/or sweeplines.

FIG. 13 is a front side view of the trawl system showing a specific embodiment of a construction and method for affixing and orientating light sources illuminating a wall and/or curtain of light between the trawl's footrope and/or groundline and the sea floor.

FIG. 14 is a side plan view of a light source housing adapted to be used with the light sources shown in FIG. 12, FIG. 12A and FIG. 13.

FIG. 15 is a side plan view of a rockhopper of the present disclosure containing both a light source housing containing a light source as well as constructed to include a delta plate type attachment for connecting the lower sweep and/or bridle line to lines forming the trawl's groundline and/or footrope.

### BEST MODE FOR CARRYING OUT THE DISCLOSURE

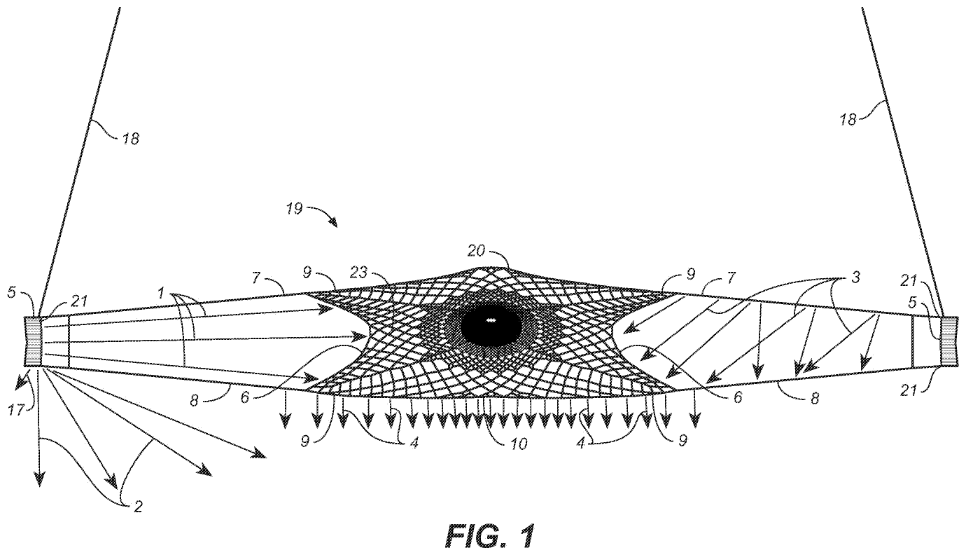

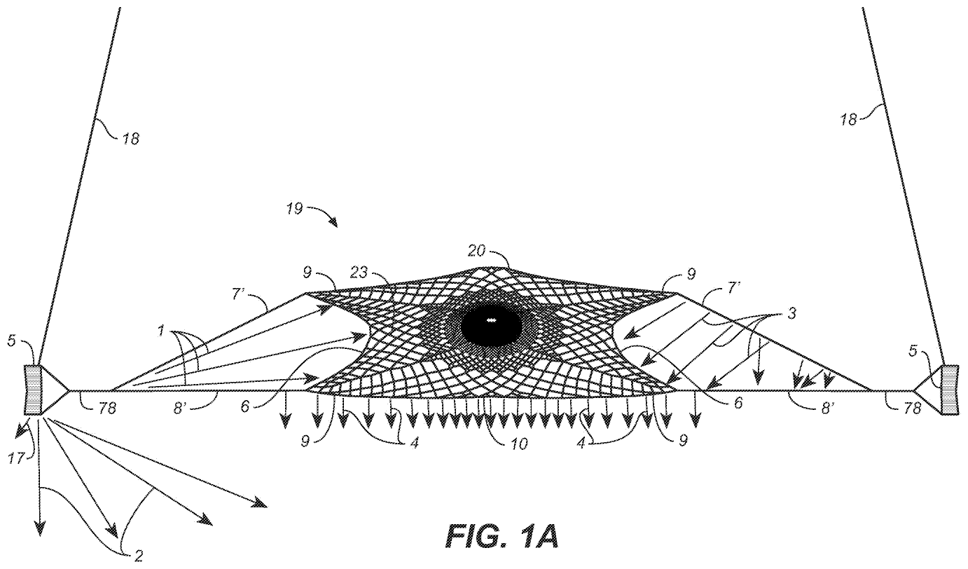

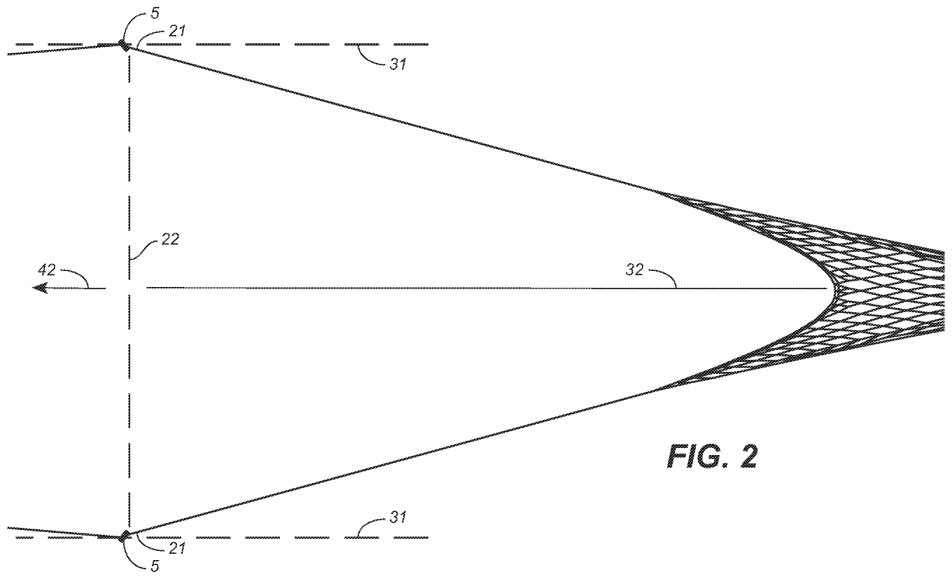

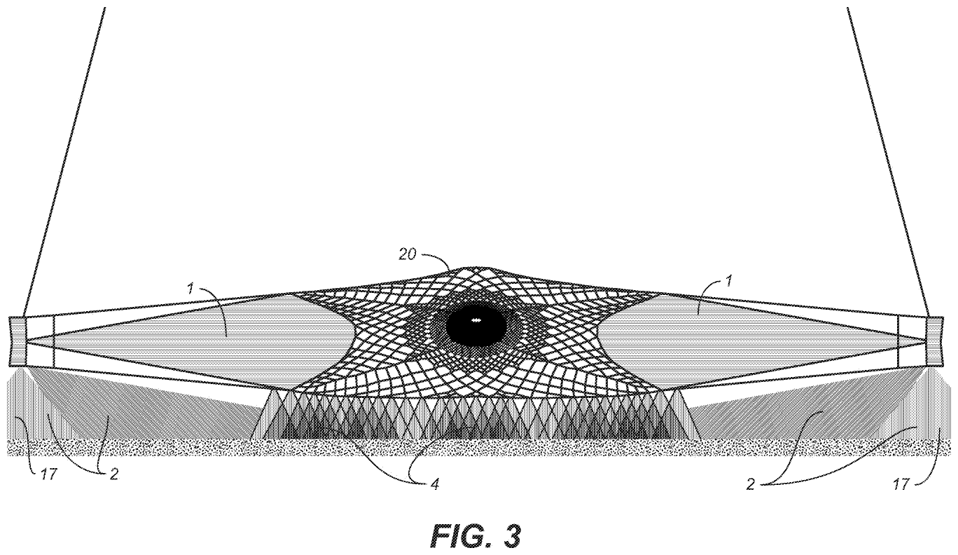

With reference to FIG. 1 and FIG. 2:

Shown is a trawl system 19 having at least a trawl 20 towed upon by bridles and/or sweeps such as upper and lower bridles and/or sweeps 7 and 8, respectively, that connect at forward bridle points 21 to, in the case of single trawling, trawl doors 5 (where trawl doors 5 are connected and towed upon by towing warps 18 depending from the trawling vessel that tows upon the towing warps and thus upon the trawl system as a whole); and, in the case of pair trawling (not shown in FIG. 1), the forward bridle points 21 connect to towing warps and/or hardware connecting forward bridle points 21 to the towing warps. The trawl 20 includes trawl mouth opening 23 and wings 9, the wings connected to and towed upon by bridles and/or sweeps 7 and 8.

Light beams as indicated by arrow lines 1 are directed backward from the forward bridle points (including any backstrops or the like that connect the bridles to the trawl doors), and, preferably, from a trawl door 5, and aimed toward the side edge 6 of the mouth opening of the trawl that is on the same side of the trawl system as the trawl doors. For example, light beams 1 are aimed from a starboard side trawl door to the starboard side edges of the trawl's mouth opening, and oppositely, also are aimed from a port side trawl door to the port side edges of the trawl's mouth opening (light beams 1 are shown only on one side of the trawl system so as to not clutter the drawing, but preferably symmetrically exist on both sides of the trawl system). The quantity of light sources emanating from the trawl door and their spatial distribution and arrangement on the trawl door (including upon any hardware attached to the trawl door upon which the light sources are mounted) is such that light beams 1 preferably are arranged in number and direction of the beams so that a virtual light wall is created between: at least upper and lower sweeps and/or bridle lines 7 and 8; the near and/or proximal side edge of the trawl mouth's opening; and, the near side trawl door from which the light sources emanate. Lights that emanate a flat beam, including a flat, fan shaped beam, are considered most useful to form the virtual light wall. It is anticipated that laser lights are useful for light beams 1 for their ability to penetrate distance and to be aimed precisely. However, in some applications, strong LEDs might be useful. The direction of aim of light beams 1 does not intersect a plane extending from the sea floor to the water's surface and within which lies imaginary straight dashed line 22 extending between the forward bridle points. Most preferably, light beams 1 also do not pass through a plane extending from the sea floor to the water's surface and within which lies imaginary straight line 32 that is parallel to and coaxial with the trawl's long axis of symmetry. (For purposes of the present disclosure the terms “sea floor”, “ocean floor”, and “bottom of the body of water” are synonymous, and the terms “water's surface”, “ocean's surface”; “sea's surface” are synonymous and indicate the interface between the body of water within which is deployed the trawl system and the air above the body of water).

Light beams indicated by arrow lines 2 are aimed from a trawl door downward toward the sea floor and also downward and backward toward the direction of the trawl and generally in a plane within which lie upper and lower bridle lines and/or sweeps 7 and 8, respectively, and/or are aimed generally in the plane of wings 9 of the trawl, so as to be aimed at the outer edges 6 of the trawl's mouth opening that is on the same side of the trawl system as is the trawl door from which light beams 2 emanate, and generally so as not to cross in front of the path that the fish (including shrimps and prawns) must travel while being herded into the trawl's mouth opening. The quantity of light sources emanating from the trawl door and their spatial distribution and arrangement on the trawl door (including upon any hardware attached to the trawl door upon which the light sources are mounted) is such that light beams 2 create a virtual light wall beneath the trawl door toward the sea floor, and beneath the lower bridle lines and/or sweeps toward the sea floor, in a zone spanning from beneath the trawl door to a location proximal the trawl mouth's near side opening edge. Lights that emanate a flat beam, including a flat, fan shaped beam, are considered most useful to form the virtual light wall. It is anticipated that laser lights are useful for light beams 2 for their ability to penetrate distance and to be aimed precisely. However, in some applications, strong LEDs might be useful. (Light beams 2 are shown only on one side of the trawl system so as to not clutter the drawing, but preferably symmetrically exist on both sides of the trawl system.) The direction of aim of light beams 2 does not intersect a plane extending from the sea floor to the water's surface and within which lies imaginary straight dashed line 22 extending between the forward bridle points. Most preferably, light beams 2 also do not pass through a plane extending from the sea floor to the water's surface and within which lies imaginary straight line 32 that is parallel to and coaxial with the trawl's long axis of symmetry.

Optionally, and anticipated useful, light beams indicated by arrow line 17 are aimed from the trawl door both forward as well as angled both outward and downward, so as not to intersect either of two planes that extend from the sea floor to the water's surface and within which lies either of imaginary straight dashed lines 31 that each independently intersect a single forward bridle point and that also are parallel to the trawl's longitudinal axis of symmetry indicated by imaginary straight line 32. Light beams indicated by arrow lines 3 are aimed from upper bridles and/or sweeps 7 downward so as to preferably intersect the lower bridles and/or sweeps 8 and pass beyond lower bridles and/or sweeps 8 toward the sea floor; and/or are aimed downward and backward so as to both intersect the lower bridles and/or sweeps 8, while also being aimed at the near side edges 6 of the trawl's mouth opening. (Light beams 3 are shown only on one side of the trawl system so as to not clutter the drawing, but preferably symmetrically exist on both sides of the trawl system.) It is anticipated that laser lights are useful for light beams 3 for their ability to penetrate distance and to be aimed precisely. However, in some applications, strong LEDs might be useful. The quantity and spatial distribution of light sources per unit meter of the upper bridles and/or sweeps and the density and quantity of light beams 3 is selected so as to create a virtual light wall that either totally or mainly seals with the light beams the space defined between: the upper and lower bridles and/or sweeps; the proximal trawl mouth opening's edge, and the trawl doors. Lights that emanate a flat beam, including a flat, fan shaped beam, are considered most useful to form the virtual light wall. The direction of aim of light beams 3 does not intersect a plane extending from the sea floor to the water's surface and within which lies imaginary straight dashed line 22 extending between the forward bridle points. Most preferably, light beams 3 also do not pass through a plane extending from the sea floor to the water's surface and within which lies imaginary straight line 32 that is parallel to and coaxial with the trawl's long axis of symmetry.

Light beams indicated by arrow lines 4 are aimed from the footrope and/or groundrope 10 (and also may be aimed from a lower bridle line and/or lower sweepline 8) downward toward the sea floor. The quantity of light sources per unit meter of the footrope and/or groundrope and thus the density of light beams 4 is selected and arranged so as to create a virtual seal between the footrope and/or groundrope and the seafloor. The quantity and spatial distribution of light sources per unit meter of the footrope and/or groundrope and thus the density of light beams 4 in the center of the footrope and/or groundrope preferably is greater in density in comparison to the density of light beams 4 in other regions of the footrope and/or groundrope, such as the footrope and/or groundrope's wings. Strong LED lights are anticipated most useful for forming light beams 4, although laser lights also are anticipated useful. Light beams 4 preferably are aimed either directly downward, or downward and also slightly aft/backward, such as at a thirty degree downward angle aft/backward. Additionally, light beams 4 also may be aimed both downward as well as downward and slightly forward, such as at a thirty degree downward angle forward. The purpose of light beams 4 is to create a virtual seal between the groundrope and/or footrope and the sea floor, and optionally also between the lower sweeps and/or bridle lines and the sea floor. Lights that emanate a flat beam, including a flat, fan shaped beam, are considered most useful to form the virtual light wall depending from the groundrope/footrope to the sea floor. The direction of aim of light beams 4 does not intersect a plane extending from the sea floor to the water's surface and within which lies imaginary straight dashed line 22 extending between the forward bridle points. Most preferably, light beams 4 also do not pass through a plane extending from the sea floor to the water's surface and within which lies imaginary straight line 32 that is parallel to and coaxial with the trawl's long axis of symmetry.

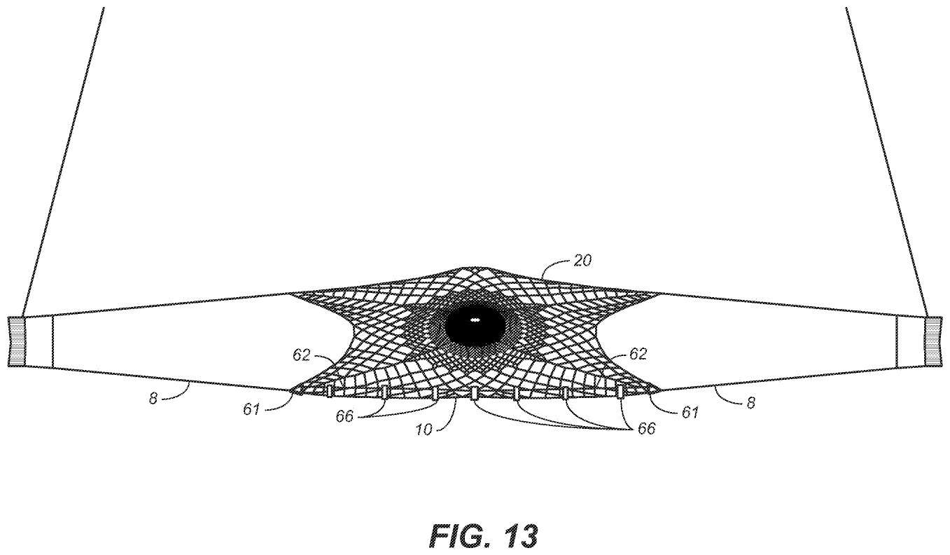

FIG. 1A depicts an alternative embodiment of the trawl system of the present disclosure depicted in FIG. 1 where the trawl depicted in FIG. 1 is rigged with an alternate arrangement to its bridles and/or sweeplines. Specifically, upper and lower bridles 7′ and 8′, respectively, connect at their fore ends to a single backstrop line 78, that in turn is connected to Vee rigged backstrops at the apex of the “V”, and the Vee rigged backstrops in turn each connect to the trawl door so that the upper leg of the Vee shaped backstrop connects to the trawl door at its upper region and so that the lower leg of the Vee shaped backstrop connects to the trawl door at its lower region. The trawl of FIG. 1A preferably is equipped with headline floats, such as trawl floats and/or trawl balls affixed to its headline, in order to provide lifting forces to its headline, that is not necessarily required for the trawl depicted in FIG. 1, FIGS. 3-12, and FIG. 13, though headline floats are able to be used with all embodiments of trawls of the present disclosure. The bridle and/or sweepline arrangements taught in FIG. 1A also is useful in combination with the various embodiments of the trawl system and trawls of the present disclosure including as depicted in the remaining FIGs of the present disclosure, including in reference to FIG. 13.

FIG. 3 is an alternate view of FIG. 1 showing specific embodiments for light beams 1, 2 and 17. As shown, light beams 1, 2 and 17 each emanate, for either the port or starboard side of the trawl system, from a single source located on the respective port or starboard trawl door. Light beams 1, 2 and 17 are shown in combination with light beams 4, as is anticipated useful.

FIG. 4 is an alternate view of the trawl system of the present disclosure where light beams 1 are the only light beams shown so as not to clutter the drawing. As shown, light beams 1 emanate from multiple light sources located on each trawl door, so as to provide more light curtain coverage to that portion of space located more proximal the trawl door than proximal the trawl mouth opening and between the upper and lower bridles.

FIG. 5 is an alternate view of the trawl system of the present disclosure where light beams 3 are the only light beams shown so as not to clutter the drawing. As shown, light beams 3 emanate from multiple light sources located on the upper bridles so as to form the curtain of light between the upper bridles and the lower bridles and/or the sea floor, extending to the edge of the trawl mouth's opening and to the trawl doors and/or to proximal the trawl doors, and optionally to the sea floor.

FIG. 6 is an alternate view of the trawl system of the present disclosure where light beams 3A are the only light beams shown so as not to clutter the drawing. As shown, light beams 3A emanate from multiple light sources located on the lower bridles so as to form the curtain of light between the lower and upper bridles, extending to the edge of the trawl mouth's opening and to the trawl doors and/or to proximal the trawl doors, and optionally to the sea floor.

FIG. 7 is an alternate view of the trawl system of the present disclosure where light beams 3 and 3A are the only light beams shown so as not to clutter the drawing. As shown, light beams 3 and 3A emanate from multiple light sources located on the upper bridles and lower bridles, respectively, so as to generate maximal light coverage from the light curtain formed in the space between the lower and upper bridles, extending to the edge of the trawl mouth's opening and to the trawl doors and/or to proximal the trawl doors, and optionally to the sea floor.

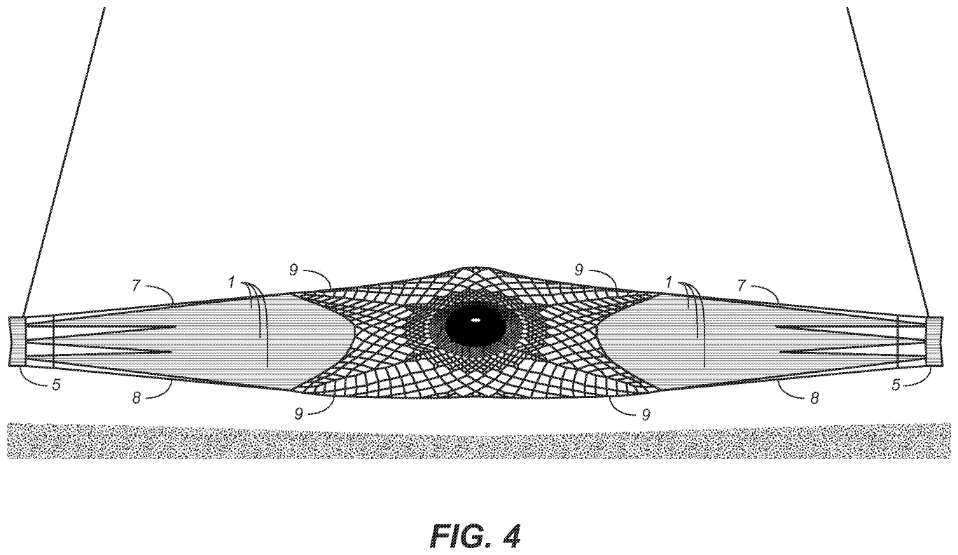

FIG. 8 is a top plan view of the trawl system of the present disclosure showing light beams 11 emanating from multiple light sources located the on starboard upper bridles and starboard side of the trawl's headline 12, and directed aimed toward the port side upper bridles and headline, respectively, so as to form a ceiling of light extending between the port and starboard upper bridles and headline from proximal the forward bridle points to the center of the trawl's mouth opening.

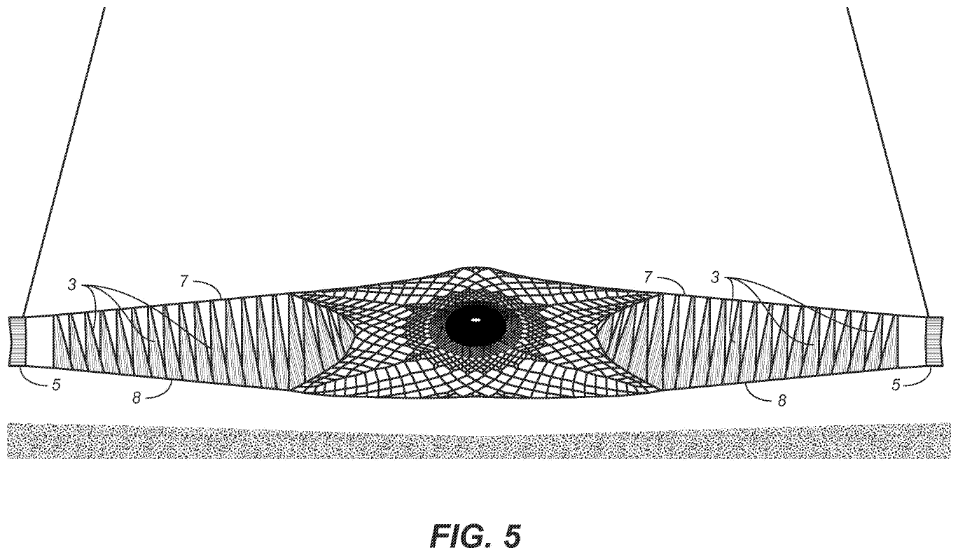

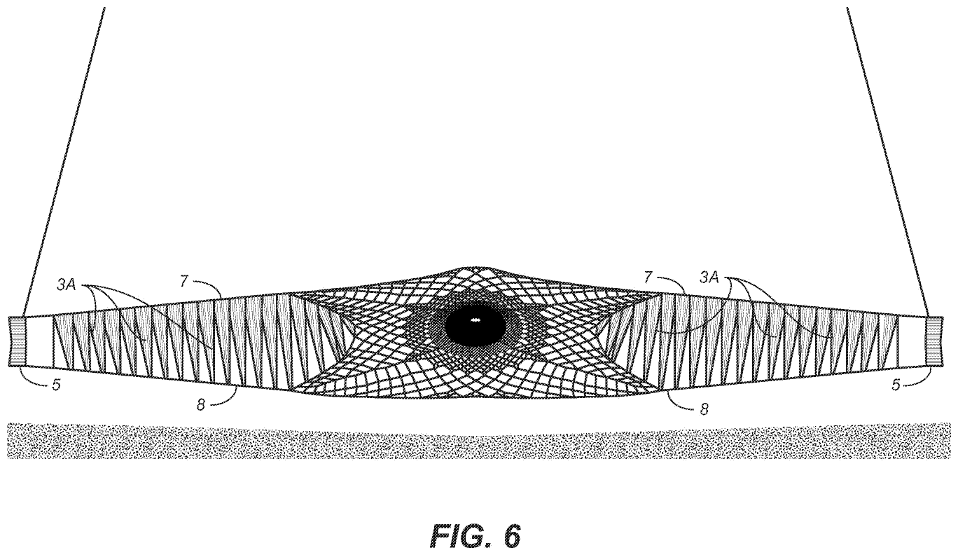

FIG. 9 is a top plan view of the trawl system of the present disclosure showing light beams 11A emanating from multiple light sources located the on port upper bridles and port side of the trawl's headline 12, and directed toward the starboard side upper bridles and headline, respectively, so as to form a ceiling of light extending between the port and starboard upper bridles and headline from proximal the forward bridle points to the center of the trawl's mouth opening.

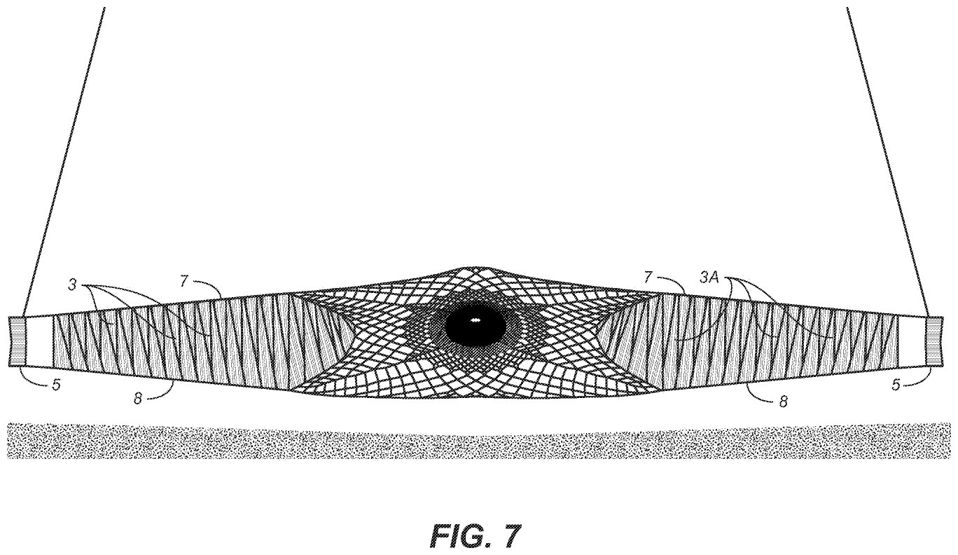

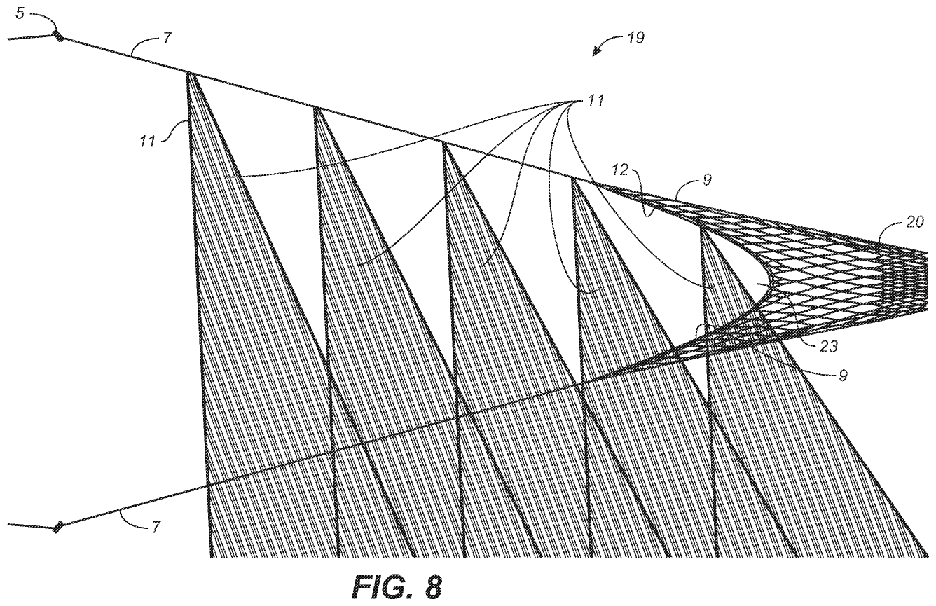

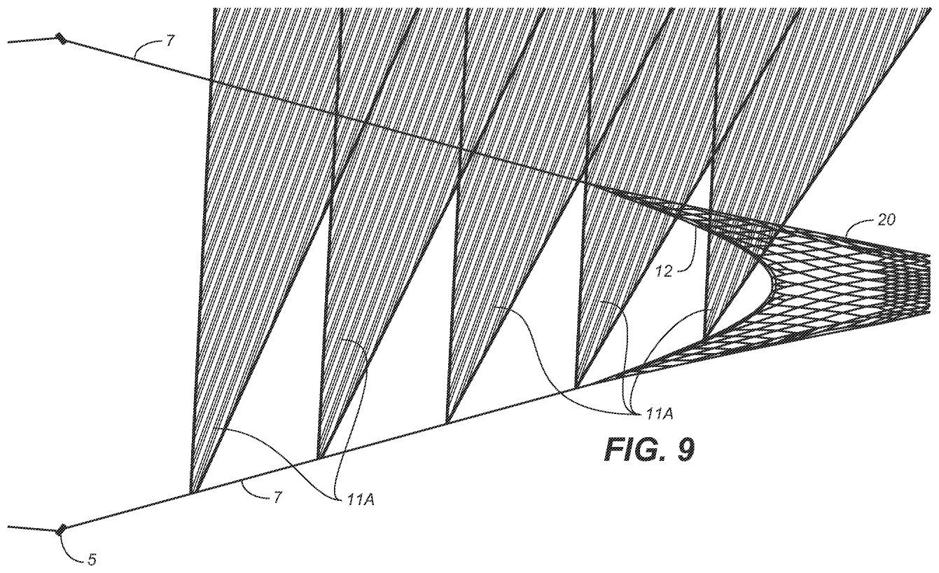

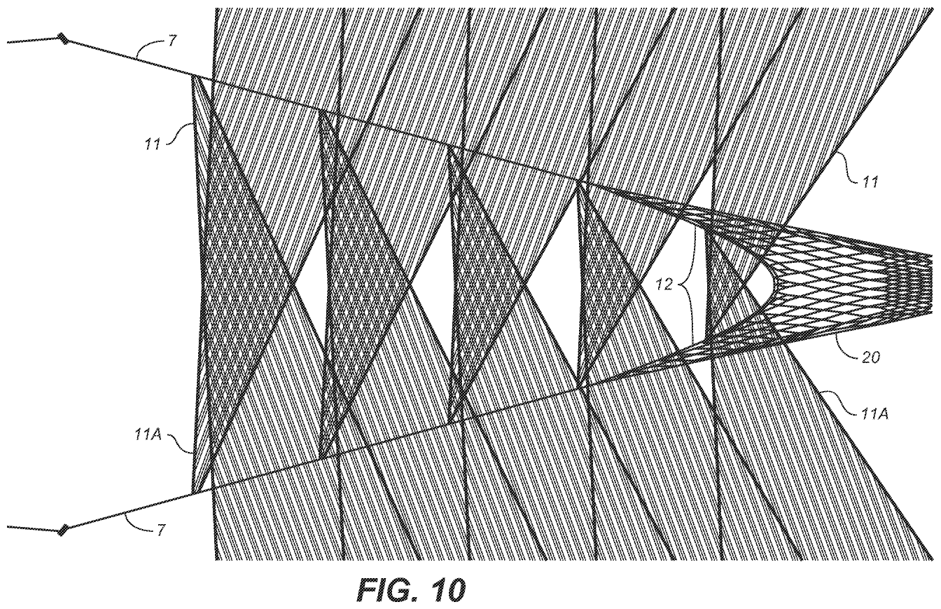

FIG. 10 is a top plan view of the trawl system of the present disclosure showing both light beams 11 and 11A forming a more dense ceiling of light extending between the port and starboard upper bridles and headline from proximal the forward bridle points to the center of the trawl's mouth opening in comparison to the ceilings of light formed by only either light beams 11 or light beams 11A.

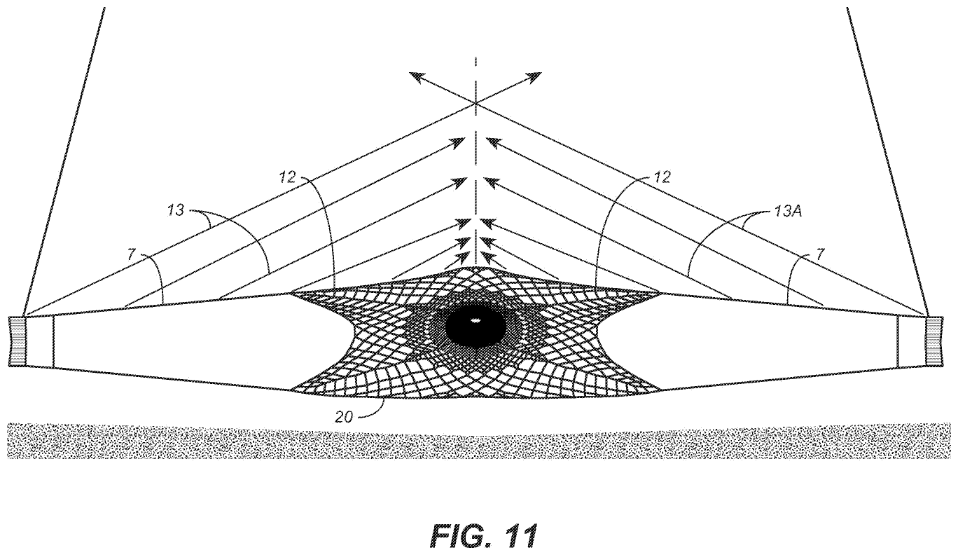

FIG. 11 is a front view of the trawl system of the present disclosure where only light beams where only light beams 13 and 13A are shown so as not to clutter the drawing. Light beams 13 emanate from multiple points on the starboard side upper bridle and headrope; whereas light beams 13A emanate from multiple points on the port side upper bridle and headrope. Light beams 13 and 13A are aimed (directed) upward (toward the water's surface/away from the sea floor) at an angle that is inboard of the trawl system so as to form a “vaulted” shaped ceiling of light extending from above the upper bridles proximal the forward bridle points (and/or more proximal the forward bridle points than proximal the trawl's wings) and toward the center of the trawl's headrope 12 so as to form a gradually downward tapering “vaulted” ceiling of light that tapers gradually downward in an aftward and/or backward direction (for example, from the forward bridle points toward the trawl net), thus having a high point forward of the trawl's mouth opening and preferably proximal the forward bridle points and having a low point proximal the trawl's mouth opening and preferably at the center of the trawl's headrope.

### Light Source Mountings

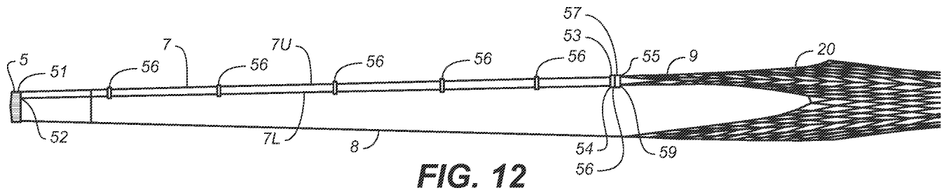

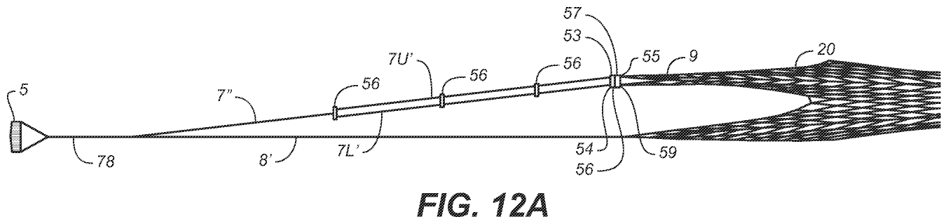

FIG. 12 shows one presently preferred method and construction for mounting light sources on the upper bridles and/or sweeps for light beams 3 that originate along various locations on the upper bridles and/or sweeps and are regulated, focused and aimed so as to form the curtain and/or wall of light between the upper and lower bridles and/or sweeps; the (preferably port and starboard) peripheral edges of the trawl's mouth opening, and the forward bridle points and/or trawl doors The drawing shows only the port side plan view of the trawl system and shows only elements essential for forming light beams 3 and lacks the light beams themselves so as not to clutter the drawing.

As shown in FIG. 12, upper bridle and/or sweep 7 is formed of two distinct lines, that preferably are synthetic ropes and/or cables, including upper bridle and/or sweep 7U and lower bridle and/or sweep 7L, both connecting and towing upon trawl 20. The distance between upper and lower bridles and/or sweeps 7U and 7L is about 0.4 meter to 1 meter, but can be greater, as needed to maintain the two lines in a vertical orientation one above the other. Upper bridle and/or sweep 7U attaches to trawl door 5 at attachment point 51 that is above (more proximal the top side of the trawl door) attachment point 52, where attachment point 52 is the attachment point of lower bridle and/or sweep 7L. At the other end of the upper bridle and/or sweep, upper bridle and or sweep 7U attaches to plate 57 at upper attachment point 53, and lower bridle and/or sweep 7L attaches to plate 57 at lower attachment point 54. At the aft end of plate 57, forked wing tips 9 of trawl 20 attach to the aft end of plate 57 at upper and lower attachment points 55 and 59, respectively.

With continued reference to FIG. 12, a plurality of light source housings 56 are disposed along the upper bridles and/or sweeps 7, 7U and 7L. A light source housing 56 also is built into plate 57. As described herein, these light source housings each contain at least one and possibly a plurality of light sources that emanate light beams 3 that form the curtain and/or wall of light that occupies the space between at least: (i) the upper and lower bridles and/or sweeps; and (ii) the near/proximal side peripheral edge of the trawl's mouth opening. Flat light beams that emanate a laser light in a flat beam, such as a flat, fan shaped laser beam, presently are preferred. The light source housings 56 must be extremely durable and able to tolerate being wound upon a trawl drum without breaking from the pressure of the bridle and/or sweep lines, and trawl net components, that are wound in successive layers about the light source housings. In some cases, it may be desired that the light source housings are removed upon retrieval of the trawl net. For example, as the bridles and/or sweeps are wound upon the trawl drum, each light source housing is removed from the bridles and/or sweeps, and then, as the trawl is being deployed, the light source housings are installed upon the bridles and/or sweeps during payout of the bridles and/or sweeps. However, it is preferred that the light source housings are sufficiently durable so as to be able to be wound upon the trawl drum with the bridles and/or sweeps and the trawl's components without incurring damage to themselves or to the light sources contained within themselves.

As seen in FIG. 12, lower bridle and/or sweep 7L is designed and configured and positioned to be located during trawling operations (e.g. to “fish”) directly below upper bridle and/or sweep 7U. Accordingly, by attaching light source housings 56 to the upper and lower bridles and/or sweeps where light source housings 56 are attached at opposing regions of their long dimension to upper and lower bridles and/or sweeps 7U and 7L, respectively, that it is possible to position light source housings 56 in a reliable vertical orientation and thus permit forming a vertical light wall and/or curtain from light beams 3. For example, by attaching light source housings 56 at one end of their long dimension, e.g. their upper region, to the upper bridle and/or sweep, and at an opposite end of their long dimension, e.g. their lower region, to the lower bridle and/or sweep, it is possible to position light source housings 56 in a reliable vertical orientation and thus permit forming a vertical light wall and/or curtain from light beams 3.

Similarly, due to the reliable orientation of light source housings 56, light source housings 56 may be used, designed and configured to house multiple light sources of different aim directions, and thus light source housings 56 also may emanate light beams 11, 11A and/or 13 and 13A, so as to form the ceiling and/or vaulted ceiling of light formed by beams 11, 11A, and 13, 13A, respectively (with reference to drawing FIGS. 8-11).

Similarly, due to the ability to reliably orient light source housings 56 obtained by attaching light source housings 56 to upper and lower lines as taught supra for the upper and lower bridles and/or sweeps, a similar construction and method is used to position light sources along the groundrope and/or footrope 10 of the trawl 20, as shown in FIG. 13 and as described in more detail below:

With reference to FIG. 13, shown are lower bridles and/or sweeps 8 connecting and towing upon delta plates 61 that in turn connect and tow upon upper footrope line 62 and footrope line 10, where footrope line 10 also is the lower footrope line, that is, it is positioned vertically below upper footrope line 62. Using the relative positioning of upper and lower footrope lines 62 and 10, light source housings 66, each containing at least one and up to several light sources, are mounted on upper and lower footrope lines 66 and 10, and are able to be reliable directed. By making upper footrope line 66 slightly more slack than lower footrope line 10, light source housings 66 are able to be aimed slightly forward and downward. The distance between upper and lower footrope lines 66 and 10 is about 0.4 meter to 1 meter, but can be greater. Light source housings 66 contain light sources that, similarly to light source housings 56, emanate flat, laser light beams 4, and preferably flat, fan shaped laser light beams, as described supra.

FIG. 12A depicts an alternative embodiment of the trawl system of the present disclosure depicted in FIG. 12 where the trawl depicted in FIG. 12 is rigged with an alternate arrangement to its bridles and/or sweeplines. Specifically, upper and lower bridles 7″ and 8′, respectively, connect at their fore ends to a single backstrop line 78, that in turn is connected to Vee rigged backstrops at the apex of the “V”, and the Vee rigged backstrops in turn each connect to the trawl door so that the upper leg of the Vee shaped backstrop connects to the trawl door at its upper region and so that the lower leg of the Vee shaped backstrop connects to the trawl door at its lower region. Upper bridle and/or sweepline 7″ in turn connects at its aft end to upper and lower upper bridles 7U and 7L, respectively. The trawl of FIG. 12A preferably is equipped with headline floats, such as trawl floats and/or trawl balls affixed to its headline, in order to provide lifting forces to its headline, that is not necessarily required for the trawl depicted in FIG. 1, FIGS. 3-12, and FIG. 13, though headline floats are able to be used with all embodiments of trawls of the present disclosure.

The bridle and/or sweepline arrangements taught in FIG. 1A and FIG. 12A also are useful in combination with the various embodiments of the trawl system and trawls of the present disclosure including as depicted in the remaining FIGs of the present disclosure, including in reference to FIG. 13.

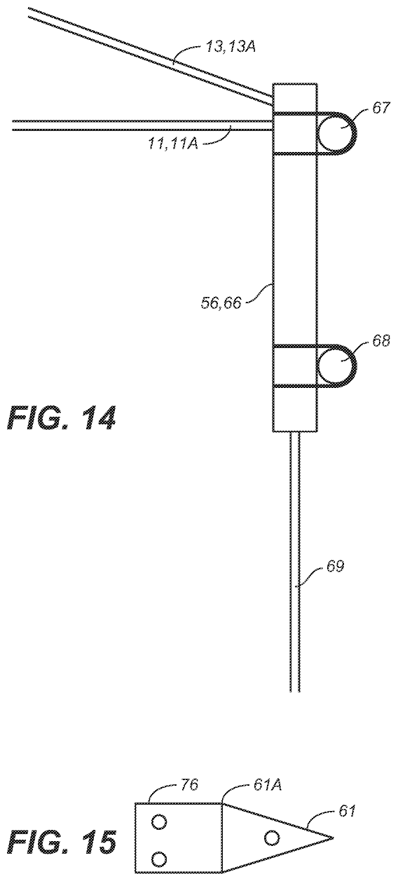

FIG. 14 is a side plan view of a light source housing 56 or 66 adapted to be used for light source housings shown in FIG. 12 and FIG. 13. As shown, light source housing 56, 66 attaches to upper and lower lines 67, 68, respectively, where upper and lower lines 67, 68 are able to correspond, when light source housing is located on the upper bridles and/or sweeps, to upper and lower sweeps and/or bridles 7U and 7L; or, that are able to correspond, when light source housing 66 is located on the upper and lower footrope lines 62 and 10, to upper and lower footrope lines 62 and 10.

Light source housing 56, 66 preferably emanates from one to a plurality of flat, laser light beams 69, preferably in a fanned shape, configured as desired, and may be used to form from light beams 69 light beams 3, 3A or 4, as well as light beams from the headrope (not shown) or from any portion of the trawl where it is desired to use upper and lower lines 67, 68 to orient the light source housings. Furthermore, light source housings 66 for the footrope may be oriented flat, e.g. so that their long length is parallel to the sea floor, by replacing upper footrope line 62 with a trailing footrope line (not shown) that is located and positioned aft and fishes aft and more or less parallel to main footrope line 10 (e.g. follows the curvature of footrope line 10).

In such embodiment, the laser light beam is not directed outward from the light source housing in a direction coaxial with the long axis of the light source housing, but rather is directed as needed so that the flat, laser light beams are still aimed downward from footrope 10 and slightly forward of footrope 10, as empirically determined optimal for various of certain specie of fish, shrimp or other.

FIG. 15 is a side plan view of a “combination delta plate plus rockhopper” 61A of the present disclosure formed of both a delta plate portion 61 and a light source housing portion 76, where the light source housing portion both contains a light source and also is adapted to include attachment through holes for connecting the lower sweep and/or bridle line to the lines forming the trawl's upper and lower groundline and/or footrope 62 and 10, respectively. This light source housing must be extremely durable and able to tolerate harsh contact with solid objects while protecting and preserving the housed light source. The delta plate portion 61 may be a typical delta plate, or, it may be conical shaped and/or generally conical shaped. The light source housing portion may be any bulky shape that permits housing the light source as well as providing the attachment through holes for connecting the lower sweep and/or bridle line to the lines forming the trawl's upper and lower groundline and/or footrope 62 and 10, respectively, with cylindrical and quadratic shapes considered useful.

### Alternative Light Source Mountings:

Preferably, light sources of the present disclosure that are mounted on any of a bridle, headrope or footrope, or other frame line of the trawl, are contained in a streamlined housing that is designed and configured to achieve its orientation relative to the trawl system due to tension on the rope and/or cable upon which the light's housing is mounted when the trawl system is deployed and being towed by a towing vessel. The orientation to the light's housing imparted to it by the tension of the rope and/or cable to which it is mounted allows the light contained within the housing to be aimed relative to the housing and thus relative to the direction of tension of the rope and/or cable to which the housing is mounted, thus allowing aiming the light beams in the directions and orientations taught herein.

To accomplish this, the housing containing the light source is rotationally mounted onto the rope and/or cable forming the portion of the trawl to which the light is mounted, e.g. a bridle, headrope, footrope or other. This may be accomplished by the light sources housing having a portion that either is a hollow pipe or has two or more sections that are hollow rings and/or collars and through which the cable and/or rope is threaded, with a stopper being fixed to the rope and/or cable and located on either side of the housing in order to prevent the housing from sliding along the rope and/or cable. In this way, rotation of the rope and/or cable portion of the trawl system to which the light source's housing is attached does not affect the orientation of the light source's housing. Furthermore, the light source's housing and all it contains preferably is neutrally buoyant and streamlined, so that it orients itself parallel to the water flow vector present when the trawl is in motion being towed by a trawling vessel. In this way, the position and orientation of the light sources housing always is able to be predicted relative to the orientation of the rope and/or cable portion of the trawl system to which it is attached when such rope and/or cable portion of the trawl system is taught (that occurs when the trawl system is in normal use being towed by a trawling vessel). Furthermore, the light itself may be housed in another unit contained within the light source's housing where such other unit is oriented relative to the earth's gravitational force vector by a pendulum construction, thereby providing yet another reliable orientation to the light source that may be used in aiming the light source (which is an especially useful embodiment when the light sources housing and all it contains is not neutrally buoyant).

Another construction for rotationally mounting the light sources housing to the rope and/or cable portion of the trawl system may be accomplished by fixing a bushing or sleeve to the rope and/or cable, and where the housing is designed and configured to be adapted to and rotationally connected to the bushing and/or sleeve by means of a collar that is adapted to rotationally connect to the bushing and/or sleeve, so that the collar is able to freely rotate about the bushing and/or sleeve and thus about the rope and/or cable to which is affixed the bushing and or sleeve.

Light sources may also be mounted on a line (e.g. a rope and/or cable) that is designed and configured to be above the trawl's footrope and more or less following the same curvature as the trawl's footrope. This line may be attached at each end of the line to a location on the trawl's port and starboard sidelines (breastlines) that, when the trawl system is in motion during regular towing by a trawler, is planned to be a predetermined distance above the footrope. By making this line neutrally buoyant and by making each light sources housing and all that each light source's housing contains neutrally buoyant, resultantly, the distance above the trawl's footrope that this line settles at during fishing operations, e.g. the distance above the footrope that this line “fishes”, remains at the predetermined distance and/or at a predetermined acceptable range of distance.

Alternatively, this line that fishes above the footrope may be retained at a predetermined distance and/or range of distance above the footrope by a plurality of lines depending from the headrope, especially where the species being fished is not deterred from entering the trawl's mouth opening by the presence of such lines.

The light sources mounted on this line that “fishes” above the footrope thus can be oriented to project their light beams in any desired direction, including forward, forward and downward, forward and backward, or other.

Similarly, using the same housings and attachment means taught herein, light sources may be attached to the forward regions of rockhopper gear and their respective light beams directed in any desired direction, including backward and inward and downward, or other.

In an alternative embodiment of the present disclosure not shown in the drawings, similarly, in the event that it is desired to mount light sources on the headrope, sidelines and/or footrope and to project forward and in front of the trawl's mouth opening a funnel of light from such light sources, the tension of the headrope, sidelines and/or footrope likewise are used to orient housings for such light beams and the light sources within such housings likewise are thus able to be reliably aimed as desired.

In the case when the light sources are mounted on a trawl door, the lights may be contained within housings that themselves have another line (rope and/or cable) connecting them to the bridles (including backstrops), where such another line is able to easily stretch, allowing the taught bridles (including backstrops) to impart an orientation to the lights' housings and thereby permit the light contained within the housing to be aimed relative to the housing and thus relative to the direction of tension of the upper and/or lower bridles, thus allowing aiming the light beams 1 and 2 (and optionally light beams 17) mounted on the trawl doors in the directions and orientations taught herein.

Light beams 17 mounted on the trawl doors also are able to be aimed by using the trawl warps as a source of tension to aim the lights housing and thus the lights, permitting aiming light beams 17 downward and outboard of the trawl doors as taught herein.

### Examples of the Present Invention

The following examples of the present invention as well as any examples provided in the instant disclosure are prophetic examples, and are anticipated to be useful:

### The Examples

1. A trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the trawl system characterized by the fact that the trawl system includes light sources illuminating space between the upper and lower bridles and/or sweeplines with visible light.
2. The trawl system of example 1 further comprising trawl doors.
3 The trawl system of example 2 further characterized by the fact that visible light illuminating space between the upper and lower bridles and/or sweeplines emanates from light sources mounted on the trawl doors.
4. The trawl system of example 3 wherein light beams emanating from the light sources mounted on the trawl doors are directed aft and/or backward and toward the mouth opening of the trawl net.
5 The trawl system of example 4 wherein the light beams that are directed aft and/or backward and toward the mouth opening of the trawl net are directed at the peripheral port and/or starboard edges of the mouth opening of the trawl net.
6. The trawl system of example 1 further characterized by the fact that visible light illuminating space between the upper and lower bridles and/or sweeplines emanates from light sources situated more proximal the forward bridle points than proximal the trawl's mouth opening.
7. The trawl system of example 6 wherein light beams emanating from the light sources situated more proximal the forward bridle points than proximal the trawl's mouth opening are directed aft and/or backward and toward the mouth opening of the trawl net.
8. The trawl system of example 7 wherein the light beams that are directed aft and/or backward and toward the mouth opening of the trawl net are directed at the peripheral port and/or starboard edges of the mouth opening of the trawl net.
9. The trawl system of example 1 further characterized by the fact that visible light illuminating space between the upper and lower bridles and/or sweeplines emanates from light sources mounted on the upper bridles and/or sweep lines.
10. The trawl system of any of the above examples wherein the light sources comprise at least one light source.
11. The trawl system of any of the above examples wherein the light sources comprise a plurality of light sources.
12. The trawl system of any of the above examples further characterized by the fact that the space between the upper and lower bridles and/or sweeplines is entirely illuminated with visible light.
13. The trawl system of any of the above examples further characterized by the fact that the space between the upper and lower bridles and/or sweeplines is partially illuminated with visible light.
14 The trawl system of any of the above examples further characterized by the fact that the space between the upper and lower bridles and/or sweeplines is partially illuminated with visible light in such a fashion as to form the appearance of a wall and/or curtain of light perforated by non illuminated regions.
15. The trawl system of any of the above examples further characterized by the fact that the space between the upper and lower bridles and/or sweeplines is partially illuminated with visible light in such a fashion as to form the appearance of lattice work type fence of visible light perforated with dark regions.
16. The trawl system of any of the above examples further characterized by the fact that the light beams emanating from the light sources primarily exclusively are aimed so as not to intersect a plane lying parallel to the earth's gravitational force vector and within which lies an imaginary straight line extending between the forward bridle points.
17. The trawl system of any of the above examples further characterized by the fact that the light beams emanating from the light sources primarily are not directed forward.
18. The trawl system of any of the above examples further characterized by the fact that the light beams emanating from the light sources are exclusively aimed so as not to intersect a plane lying parallel to the earth's gravitational force vector and within which lies an imaginary straight line extending between the forward bridle points.
19. The trawl system of any of the above examples further characterized by the fact that the light beams emanating from the light sources exclusively are not directed forward.
20. The trawl system of any of the above examples further characterized by the fact that the light beams emanating from the light sources primarily are directed in orientations other than forward.
21. The trawl system of any of the above examples further characterized by the fact that the light beams emanating from the light sources exclusively are directed in orientations other than forward.
22. A trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the trawl system characterized by the fact that the trawl system includes light sources illuminating space between the port and starboard upper bridles and/or sweeplines with visible light.
23. The trawl system of example 22 further characterized by the fact that visible light illuminating space between the upper bridles and/or sweeplines emanates from light sources mounted on one or both of the upper bridles and/or sweep lines.
24. The trawl system of example 22 further characterized by the fact that visible light illuminating space between port and starboard upper bridles and/or sweeplines emanates from light sources mounted on at least one or both of the port and starboard upper bridles and/or sweeplines.
25. The trawl system of any of the above examples wherein the light sources comprise at least one light source.
26. The trawl system of any of the above examples wherein the light sources comprise a plurality of light sources.
27. The trawl system of any of the above examples further characterized by the fact that the space between the upper bridles and/or sweeplines is entirely illuminated with visible light.
28. The trawl system of any of the above examples further characterized by the fact that the space between the upper bridles and/or sweeplines is partially illuminated with visible light.
29. The trawl system of any of the above examples further characterized by the fact that the space between the upper bridles and/or sweeplines is partially illuminated with visible light in such a fashion as to form the appearance of a ceiling of light perforated by non-illuminated regions.
30. The trawl system of any of the above examples further characterized by the fact that the space between the upper bridles and/or sweeplines is partially illuminated with visible light in such a fashion as to form the appearance of trellis of visible light perforated with dark regions.
31. The trawl system of any of the above examples further characterized by the fact that the light beams emanating from the light sources primarily exclusively are aimed so as not to intersect a plane lying parallel to the earth's gravitational force vector and within which lies an imaginary straight line extending between the forward bridle points.
32. The trawl system of any of the above examples further characterized by the fact that the light beams emanating from the light sources primarily are not directed forward.
33. The trawl system of any of the above examples further characterized by the fact that the light beams emanating from the light sources are exclusively aimed so as not to intersect a plane lying parallel to the earth's gravitational force vector and within which lies an imaginary straight line extending between the forward bridle points.
34. The trawl system of any of the above examples further characterized by the fact that the light beams emanating from the light sources exclusively are not directed forward.
35. The trawl system of any of the above examples further characterized by the fact that the light beams emanating from the light sources primarily are directed in orientations other than forward.
36. The trawl system of any of the above examples further characterized by the fact that the light beams emanating from the light sources exclusively are directed in orientations other than forward.
37. A trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the trawl system characterized by the fact that the trawl system includes light sources that form an illuminated vaulted ceiling-shaped ceiling of visible light having the lower and widest edges of the vaulted ceiling of light coinciding with the positions situated mainly along the lengths of the port and starboard upper bridles and/or sweeplines.
38. The trawl system of example 37 further characterized by the fact that visible light illuminating the vaulted shaped ceiling of light emanates from light sources mounted on one or both of the upper bridles and/or sweep lines.
39. The trawl system of example 37 further characterized by the fact that visible light illuminating the vaulted shaped ceiling of light emanates from light sources mounted on at least one or both of the port and starboard upper bridles and/or sweeplines.
40. The trawl system of any of the above examples wherein the light sources comprise at least one light source.
41. The trawl system of any of the above examples wherein the light sources comprise a plurality of light sources.
42. The trawl system of any of the above examples further characterized by the fact that the vaulted ceiling is entirely illuminated with visible light.
43. The trawl system of any of the above examples further characterized by the fact that the vaulted ceiling is partially illuminated with visible light.
44. The trawl system of any of the above examples further characterized by the fact that the vaulted ceiling is partially illuminated with visible light in such a fashion as to form the appearance of a vaulted ceiling of light perforated by non-illuminated regions.
45. The trawl system of any of the above examples further characterized by the fact that the vaulted ceiling is partially illuminated with visible light in such a fashion as to form the appearance of vaulted trellis of visible light perforated with dark regions.
46. The trawl system of any of the above examples further characterized by the fact that the light beams emanating from the light sources primarily exclusively are aimed so as not to intersect a plane lying parallel to the earth's gravitational force vector and within which lies an imaginary straight line extending between the forward bridle points.
47. The trawl system of any of the above examples further characterized by the fact that the light beams emanating from the light sources primarily are not directed forward.
48. The trawl system of any of the above examples further characterized by the fact that the light beams emanating from the light sources are exclusively aimed so as not to intersect a plane lying parallel to the earth's gravitational force vector and within which lies an imaginary straight line extending between the forward bridle points.
49. The trawl system of any of the above examples further characterized by the fact that the light beams emanating from the light sources exclusively are not directed forward.
50 The trawl system of any of the above examples further characterized by the fact that the light beams emanating from the light sources primarily are directed in orientations other than forward.
51. The trawl system of any of the above examples further characterized by the fact that the light beams emanating from the light sources exclusively are directed in orientations other than forward.
52 The trawl system of any one of examples 9 to 52 further characterized by the fact that the light sources are contained within light source housings, and that the light source housings are attached to an upper and a lower taught line.
53. A trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the trawl system characterized by the fact that the trawl system includes light sources directing visible light beams downward from the trawl's pliable footrope toward the sea floor.
54. The trawl system of example 53 further characterized by the fact that visible light directed downwards from the trawl's pliable footrope toward the sea floor includes light sources included with light source housings mounted on an upper and lower footrope line.
55. The trawl system of any one of examples 53 and 54 further characterized by the fact that the visible light directed from the trawl's pliable footrope toward the sea floor forms a more dense and/or more bright barrier of light proximal the center of the footrope than proximal the region of the footrope corresponding to the trawl's wings.
56. The trawl system of any one of the above examples where the light beams are laser light beams.
57 The trawl system of any one of the above examples where the light beams form flat light beams.
58. The trawl system of any one of the above examples where the light beams are laser light beams forming flat, fan shaped rays of light.
59. The trawl system of any one of the above examples where trawl doors of the trawl system have at least one trawl door having at least one light source situated upon it that directs light beams in a direction that both is forward of as well as outboard of the trawl door.
60. The trawl system of example 59 wherein light beams emanating from a light source situated upon the trawl door also are directed downward from the trawl door.
61. The trawl system of any one of examples 59 and 60 wherein light beams emanating from a light source situated upon the trawl door also are directed backward from the trawl door and towards the peripheral edges of the trawl's mouth opening.
62. The trawl system of example 59 where the light beams primarily exclusively are aimed so as not to intersect a plane lying parallel to the earth's gravitational force vector and within which lies an imaginary straight line that is parallel and coaxial with the longitudinal axis of the trawl system at any location that is forward of the trawl's mouth opening.
63. The trawl system of any one of examples 59 to 62 further characterized by the fact that the light beams emanating from the light sources primarily are not directed inboard of the trawl door relative to the trawl system.
64 The trawl system of any one of examples 59 to 63 of the above examples further characterized by the fact that the light beams emanating from the light sources are exclusively aimed so as not to intersect a plane lying parallel to the earth's gravitational force vector and within which lies an imaginary straight line extending between the forward bridle points.
65. The trawl system of any one of examples 59 to 64 further characterized by the fact that the light beams emanating from the light sources exclusively are aimed in directions that both are not directed forward and parallel to the longitudinal axis of the trawl system.
66. The trawl system of any one of examples 59 to 65 further characterized by the fact that the light beams emanating from the light sources primarily are aimed in directions other than both forward and parallel to the longitudinal axis of the trawl system.
67. A process for herding and harvesting fish, prawns and shrimps using a trawl system, the trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the process comprising selecting to affix light sources to the trawl system and further selecting to illuminate space between the upper and lower bridles and/or sweeplines with visible light from the light sources
68. The process of example 67 further comprising selecting to include trawl doors in the trawl system.
69. The process of example 68 further comprising illuminating space between the upper and lower bridles and/or sweeplines from light sources mounted on the trawl doors.
70. The process of example 69 further comprising selecting to direct light beams emanating from the light sources mounted on the trawl doors aft and/or backward and toward the mouth opening of the trawl net.
71. The process of example 70 further comprising selecting to direct the light beams that are directed aft and/or backward and toward the mouth opening of the trawl net at the peripheral port and/or starboard edges of the mouth opening of the trawl net.
72. The process of example 67 further comprising selecting for visible light illuminating space between the upper and lower bridles and/or sweeplines light that emanates from light sources situated more proximal the forward bridle points than proximal the trawl's mouth opening.
73. The process of example 72 further comprising selecting to direct light beams emanating from light sources situated more proximal the forward bridle points than proximal the trawl's mouth opening in a direction that is aft and/or backward and toward the mouth opening of the trawl net.
74. The process of example 73 further comprising selecting to direct the light beams that are directed aft and/or backward and toward the mouth opening of the trawl net in a direction that aims the light beams at the peripheral port and/or starboard edges of the mouth opening of the trawl net.
75. The process of example 67 further comprising selecting for that visible light illuminating space between the upper and lower bridles and/or sweeplines light that emanates from light sources mounted on the upper bridles and/or sweep lines.
76. The process of any of examples 67 to 75 further comprising selecting for the light sources at least one light source.
77 The process of any of examples 67 to 75 further comprising selecting for the light sources a plurality of light sources.
78. The process of any one of examples 67 to 77 further comprising selecting to entirely illuminate the space between the upper and lower bridles and/or sweeplines with visible light.
79. The process of any one of examples 67 to 77 further comprising selecting to partially illuminate the space between the upper and lower bridles and/or sweeplines with visible light.
80. The process of any one of examples 67 to 77 further comprising selecting to partially illuminate with visible light the space between the upper and lower bridles and/or sweeplines in such a fashion as to form the appearance of a wall and/or curtain of light perforated by non-illuminated regions.
81. The process of any one of examples 67 to 77 further comprising selecting to illuminate with visible light the space between the upper and lower bridles and/or sweeplines in such a fashion as to form the appearance of a lattice work type fence of visible light perforated with dark regions.
82. The process of any one of example 67 to 81 further comprising selecting to aim the light beams emanating from the light sources primarily in a direction so as not to intersect a plane lying parallel to the earth's gravitational force vector and within which lies an imaginary straight line extending between the forward bridle points.
83. The process of any one of examples 67 to 82 further comprising selecting to aim the light beams emanating from the light sources primarily in a direction other than forward.
84. The process of any one of example 67 to 81 further comprising selecting to aim the light beams emanating from the light sources exclusively in a direction so as not to intersect a plane lying parallel to the earth's gravitational force vector and within which lies an imaginary straight line extending between the forward bridle points.
85. The process of any one of examples 67 to 82 further comprising selecting to aim the light beams emanating from the light sources exclusively in a direction other than forward.
86. The process of any one of examples 67 to 85 further comprising selecting to primarily aim the light beams emanating from the light sources in orientations other than forward.
87. The process of any one of examples 67 to 86 further comprising selecting to exclusively aim the light beams emanating from the light sources in orientations other than forward.
88. A process for herding and harvesting fish, prawns and shrimps with a trawl system, the trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the process comprising selecting to use light sources to illuminate space between the port and starboard upper bridles and/or sweeplines with visible light.
89. The process of example 88 further comprising selecting for the visible light illuminating space between the upper bridles and/or sweeplines light emanating from light sources mounted on one or both of the upper bridles and/or sweep lines.
90. The process of example 88 further comprising selecting for the visible light illuminating space between the port and starboard upper bridles and/or sweeplines light emanating from light sources mounted on at least one or both of the port and starboard upper bridles and/or sweeplines.
91. The process of any of examples 88 to 90 further comprising selecting for the light sources at least one light source.
92. The process of any of examples 88 to 90 further comprising selecting for the light sources a plurality of light sources.
93. The process of any one of examples 88 to 92 further comprising selecting to entirely illuminate the space between the upper bridles and/or sweeplines with visible light.
94. The process of any one of examples 88 to 92 further comprising selecting to partially illuminate the space between the upper bridles and/or sweeplines with visible light.
95. The process of any one of examples 88 to 94 further comprising selecting to partially illuminate with visible light the space between the upper bridles and/or sweeplines in such a fashion as to form the appearance of a ceiling of light perforated by non-illuminated regions.
96. The process of any one of examples 88 to 94 further comprising selecting to partially illuminate with visible light the space between the upper bridles and/or sweeplines in such a fashion as to form the appearance of a trellis of visible light perforated with dark regions.
97. The process of any one of examples 88 to 96 further comprising selecting to aim the light beams emanating from the light sources primarily in a direction so as not to intersect a plane lying parallel to the earth's gravitational force vector and within which lies an imaginary straight line extending between the forward bridle points.
98. The process of any one of examples 88 to 96 further comprising selecting to aim the light beams emanating from the light sources primarily in a direction other than forward.
99. The process of any one of examples 88 to 96 further comprising selecting to aim the light beams emanating from the light sources exclusively in a direction so as not to intersect a plane lying parallel to the earth's gravitational force vector and within which lies an imaginary straight line extending between the forward bridle points.
100. The process of any one of examples further comprising selecting to aim the light beams emanating from the light sources exclusively in a direction other than forward.
101. The process of any one of examples 88 to 96 further comprising selecting to primarily aim the light beams emanating from the light sources in orientations other than forward.
102. The process of any one of examples 88 to 96 further comprising selecting to exclusively aim the light beams emanating from the light sources in orientations other than forward.
103. A process for herding and harvesting fish, prawns and shrimps with a trawl system, the trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the process comprising situating light sources and directing light beams from the light sources so that the light beams form an illuminated vaulted ceiling shaped ceiling of visible light having the lower and widest edges of the vaulted ceiling of light coinciding with the positions situated mainly along the lengths of the port and starboard upper bridles and/or sweeplines.
104. The process of example 103 further comprising selecting to illuminate the vaulted shaped ceiling of light with light emanating from light sources mounted on one or both of the upper bridles and/or sweep lines.
105. The process of example 103 further comprising selecting to illuminate the vaulted shaped ceiling of light with light emanating from light sources mounted on at least one or both of the port and starboard upper bridles and/or sweeplines.
106. The process of any of examples 103 to 105 further comprising selecting for the light sources at least one light source.
107. The process of any of examples 103 to 105 further comprising selecting for the light sources a plurality of light sources.
108. The process of any one of examples 103 to 107 further comprising selecting to form the vaulted ceiling partially illuminated with visible light.
109. The process of any one of examples 103 to 107 further comprising selecting to form the vaulted ceiling entirely illuminated with visible light.
110. The process of any one of examples 103 to 107 further comprising selecting to form the vaulted ceiling partially illuminated with visible light in such a fashion as to form the appearance of a vaulted ceiling of light perforated by non-illuminated regions.
111. The process of any one of examples 103 to 107 further comprising selecting to form the vaulted ceiling partially illuminated with visible light in such a fashion as to form the appearance of a vaulted trellis of visible light perforated with dark regions.
112. The process of any one of examples 103 to 111 further comprising selecting to aim the light beams emanating from the light sources primarily in a direction so as not to intersect a plane lying parallel to the earth's gravitational force vector and within which lies an imaginary straight line extending between the forward bridle points.
113 The process of any one of examples 103 to 111 further comprising selecting to aim the light beams emanating from the light sources primarily in a direction other than forward.
114. The process of any one of examples 103 to 111 further comprising selecting to aim the light beams emanating from the light sources exclusively in a direction so as not to intersect a plane lying parallel to the earth's gravitational force vector and within which lies an imaginary straight line extending between the forward bridle points.
115. The process of any one of examples 103 to 111 further comprising selecting to aim the light beams emanating from the light sources exclusively in a direction other than forward.
116. The process of any one of examples 103 to 111 further comprising selecting to primarily aim the light beams emanating from the light sources in orientations other than forward.
117. The process of any one of examples 103 to 111 further comprising selecting to exclusively aim the light beams emanating from the light sources in orientations other than forward.
118. The process of any one of examples 75 to 117 further comprising selecting to contain the light sources within light source housings, and further comprising selecting to attach the light source housings to an upper and a lower taught line.
119. A process for herding and harvesting fish, prawns and shrimps with a trawl system, the trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the process comprising selecting to include light sources directing visible light beams downward from the trawl's pliable footrope toward the sea floor.
120. The process of example 119 further comprising selecting to direct visible light downwards from the trawl's pliable footrope toward the sea floor and including light sources included within light source housings and selecting to mount the light source housings on an upper and lower footrope line.
121. The process of any one of examples 119 to 120 further comprising selecting to form a more dense and/or more bright barrier of light proximal the center of the footrope than proximal the region of the footrope corresponding to the trawl's wings.
122. The process of any one of examples 119 to 121 further comprising selecting for light beams emanating from the light sources light beams that are laser light beams.
123. The process of any one of examples 119 to 122 further comprising selecting for light beams emanating from the light sources light beams that form flat light beams.
124. The process of any one of examples 119 to 123 further comprising selecting for light beams emanating from the light sources light beams that form flat, fan shaped rays of light.
125. The process of any one of examples 119 to 123 further comprising selecting to include trawl doors with the trawl system and further comprising selecting to situate on at least one trawl door at least one light source that directs light beams in a direction that both is forward of as well as outboard of the trawl door.
126. The process of example 125 further comprising selecting to direct downward from the trawl door light beams emanating from a light source situated upon the trawl door.
127. The process of any one of examples 125 to 126 further comprising selecting to direct light beams emanating from a light source situated upon the trawl door in a direction that is aimed backward from the trawl door and towards the peripheral edges of the trawl's mouth opening.
128. The process of example 127 further comprising selecting to primarily aim the light beams in such a fashion that the light beams do not to intersect a plane lying parallel to the earth's gravitational force vector and within which lies an imaginary straight line that is parallel and coaxial with the longitudinal axis of the trawl system at any location that is forward of the trawl's mouth opening.
129 The process of any one of examples 119 to 128 further comprising selecting to direct light beams emanating from the light sources in such a fashion that the light beams primarily are not directed inboard of the trawl door relative to the trawl system.
130. The process of any one of examples 119 to 129 further comprising selecting to primarily aim the light beams in such a fashion that the light beams emanating from the light sources are exclusively aimed so as not to intersect a plane lying parallel to the earth's gravitational force vector and within which lies an imaginary straight line extending between the forward bridle points.
131. The process of any one of examples 119 to 130 further comprising selecting to primarily aim the light beams in such a fashion that the light beams emanating from the light sources exclusively are aimed in directions that both are not directed forward and parallel to the longitudinal axis of the trawl system.
132. The process of any one of examples 119 to 130 further comprising selecting to primarily aim the light beams in such a fashion that the light beams emanating from the light sources exclusively are aimed in directions other than both forward and parallel to the longitudinal axis of the trawl system.

Although the present disclosure has been described in terms of the presently preferred embodiment, it is to be understood that such disclosure is purely illustrative and is not to be interpreted as limiting. Consequently, without departing from the spirit and scope of the disclosure, various alterations, modifications and/or alternative applications of the disclosure are, no doubt, able to be understood by those ordinarily skilled in the art upon having read the preceding disclosure. Accordingly, it is intended that the following claims be interpreted as encompassing all alterations, modifications or alternative applications as fall within the true spirit and scope of the disclosure.

1. A trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the trawl system characterized by the fact that the trawl system includes light sources illuminating space between the upper and lower bridles and/or sweeplines with visible light.

2. The trawl system of claim 1 further comprising trawl doors.

3. The trawl system of claim 2 further characterized by the fact that visible light illuminating space between the upper and lower bridles and/or sweeplines emanates from light sources mounted on the trawl doors.

4. The trawl system of claim 3 wherein light beams emanating from the light sources mounted on the trawl doors are directed aft and/or backward and toward the mouth opening of the trawl net.

5. The trawl system of claim 4 wherein the light beams that are directed aft and/or backward and toward the mouth opening of the trawl net are directed at the peripheral port and/or starboard edges of the mouth opening of the trawl net.

6. The trawl system of claim 1 further characterized by the fact that visible light illuminating space between the upper and lower bridles and/or sweeplines emanates from light sources situated more proximal the forward bridle points than proximal the trawl's mouth opening.

7. The trawl system of claim 6 wherein light beams emanating from the light sources situated more proximal the forward bridle points than proximal the trawl's mouth opening are directed aft and/or backward and toward the mouth opening of the trawl net.

8. The trawl system of claim 7 wherein the light beams that are directed aft and/or backward and toward the mouth opening of the trawl net are directed at the peripheral port and/or starboard edges of the mouth opening of the trawl net.

9. The trawl system of claim 1 further characterized by the fact that visible light illuminating space between the upper and lower bridles and/or sweeplines emanates from light sources mounted on the upper bridles and/or sweep lines.

10. A trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the trawl system characterized by the fact that the trawl system includes light sources illuminating space between the port and starboard upper bridles and/or sweeplines with visible light.

11. The trawl system of claim 10 further characterized by the fact that visible light illuminating space between the upper bridles and/or sweeplines emanates from light sources mounted on one or both of the upper bridles and/or sweep lines.

12. A trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the trawl system characterized by the fact that the trawl system includes light sources that form an illuminated vaulted ceiling shaped ceiling of visible light having the lower and widest edges of the vaulted ceiling of light coinciding with the positions situated mainly along the lengths of the port and starboard upper bridles and/or sweeplines.

13. A trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the trawl system characterized by the fact that the trawl system includes light sources directing visible light beams downward from the trawl's pliable footrope toward the sea floor.

14. The trawl system of claim 13 further characterized by the fact that visible light directed downwards from the trawl's pliable footrope toward the sea floor includes light sources included with light source housings mounted on an upper and lower footrope line.

15. The trawl system of any one of claims 13 and 14 further characterized by the fact that the visible light directed from the trawl's pliable footrope toward the sea floor forms a more dense and/or more bright barrier of light proximal the center of the footrope than proximal the region of the footrope corresponding to the trawl's wings.

16. A process for herding and harvesting fish, prawns and shrimps using a trawl system, the trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the process comprising selecting to affix light sources to the trawl system and further selecting to illuminate space between the upper and lower bridles and/or sweeplines with visible light from the light sources

17. The process of claim 16 further comprising selecting to include trawl doors in the trawl system.

18. The process of claim 17 further comprising illuminating space between the upper and lower bridles and/or sweeplines from light sources mounted on the trawl doors.

19. A process for herding and harvesting fish, prawns and shrimps with a trawl system, the trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the process comprising selecting to use light sources to illuminate space between the port and starboard upper bridles and/or sweeplines with visible light.

20. The process of claim 19 further comprising selecting for the visible light illuminating space between the upper bridles and/or sweeplines light emanating from light sources mounted on one or both of the upper bridles and/or sweep lines.

21. A process for herding and harvesting fish, prawns and shrimps with a trawl system, the trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the process comprising situating light sources and directing light beams from the light sources so that the light beams form an illuminated vaulted ceiling shaped ceiling of visible light having the lower and widest edges of the vaulted ceiling of light coinciding with the positions situated mainly along the lengths of the port and starboard upper bridles and/or sweeplines.

22. The process of claim 21 further comprising selecting to illuminate the vaulted shaped ceiling of light with light emanating from light sources mounted on one or both of the upper bridles and/or sweep lines.

23. The process of any one of claims 21 to 22 further comprising selecting to contain the light sources within light source housings, and further comprising selecting to attach the light source housings to an upper and a lower taught line.

24. A process for herding and harvesting fish, prawns and shrimps with a trawl system, the trawl system having at least a trawl net and bridles and/or sweeplines, the trawl net having at least:
a trawl mouth opening; wings; a pliable footrope; a pliable headrope; and pliable sidelines,
the bridles and/or sweeplines having a forward bridle point as well as having upper and lower bridles and/or sweeplines,
the process comprising selecting to include light sources directing visible light beams downward from the trawl's pliable footrope toward the sea floor.

25. The process of claim 24 further comprising selecting to direct visible light downwards from the trawl's pliable footrope toward the sea floor and including light sources included within light source housings and selecting to mount the light source housings on an upper and lower footrope line.

26. The process of any one of claims 24 to 25 further comprising selecting to form a more dense and/or more bright barrier of light proximal the center of the footrope than proximal the region of the footrope corresponding to the trawl's wings.
